(19) United States
(12) Patent Application Publication
(10) Pub. No.: US 2011/0082983 A1
(43) Pub. Date: Apr. 7, 2011

(54) CPU INSTRUCTION AND DATA CACHE CORRUPTION PREVENTION SYSTEM

(75) Inventor: Toby Koktan, Nepean (CA)

(73) Assignee: ALCATEL-LUCENT CANADA, INC., Ottawa (CA)

(21) Appl. No.: 12/574,612

(22) Filed: Oct. 6, 2009

(51) Int. Cl. G06F 12/08

(52) U.S. Cl. 711/135; 711/141; 711/E12.001; 711/E12.026

(57) ABSTRACT

Various exemplary embodiments relate to a cache corruption prevention system and a related method. A cache memory may contain contents that are susceptible to corruption. A cache controller, with the use of a threshold timer, may employ various operations to flush modified cache contents into a main memory and invalidate cache contents so that they are overwritten. Some operations include periodically flushing and invalidating the whole cache memory, periodically flushing and invalidating modified contents, and periodically flushing and invalidating contents based on the time saved in the cache memory. By overwriting cache contents that might otherwise be constantly stored in the cache memory, the system minimizes the probability of cache contents becoming corrupt. The periodic updating of the main memory may also increase the probability of successfully recovering from potential cache parity errors while still maintaining high performance associated with using a cache memory.

### TECHNICAL FIELD

Embodiments disclosed herein relate generally to prevention of information corruption in a cache memory.

### BACKGROUND

The Level Cache (L1) cache is a special form of computer memory located closest to the processor in a general computer. The cache is generally much faster than random access memory (RAM), due to differences in manufacturing materials and hardware design, and is therefore used to reduce the time the processor spends accessing memory. However, the same factors that generally make cache memory much faster also make cache memory more expensive than RAM. As a result, the cache memory is generally much smaller than the RAM.

In operation, the cache temporarily stores a copy of a number of blocks of data from the RAM or main memory of the device, thereby enabling faster access to these blocks. The rows of the smaller cache memory may be constantly overwritten by various rows of data in the main memory as the processor accesses the main memory. As with main memory, the typical cache memory has grown larger and the rows of data in the main memory may not necessarily be constantly rewritten. As a result, some cache rows that are constantly called upon by the processor may be de facto permanent in the cache. This semi-permanence, however, makes these rows of cache susceptible to parasitic errors, such as corruption from soft errors like crosstalk in the chip or other external phenomenon (radiation, electric spikes, etc.). There may also be component defects in the cache memory itself that may leak current and cause retention issues for cache contents, which may lead to bit flips.

Previous implementations have generally related to techniques for systems to recover from such errors. These solutions have included detection of corrupted instructions from the instruction cache or unmodified data. Such recovery is made possible because this corrupted cache information is saved in the main memory, so a system may therefore be able to recover by simply loading the saved information back into the cache from the main memory.

Unfortunately, such recovery solutions do not address corruption of data that was modified in the cache, but not updated in the main memory. While there have been strategies, such as the write-through cache-coherency technique, which always synchronize modifications in the cache with modifications in the main memory, these strategies come with drawbacks, such as the loss in speed associated with constantly writing data to the main memory.

In view of the foregoing, it would be desirable to more reliably manage the contents of the cache memory while maintaining the performance benefit associated with a high-speed internal cache. More specifically, it would be desirable to periodically detect, synchronize, and clear cache contents before the contents become corrupted, while maintaining a cache-coherency policy that does not require excessive writes to the main memory. Other desirable aspects will be apparent to those of skill in the art upon reading and understanding the present specification.

### SUMMARY

In light of the present need for detecting and preventing corruption in the internal L1 cache memory while maintaining high performance benefits, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate a system for detecting and preventing cache corruption in cache memory, the system comprising a processor for performing a series of instructions, a main memory for storing digital data, a cache comprising a plurality of cache rows, wherein the cache is connected between the main memory and the processor, and the cache duplicates an original value of the digital data stored in the main memory into at least one cache row of the plurality of cache rows, and enables access by the processor to the digital data in each cache row, and a machine-readable medium encoded with instructions executable by the processor, wherein the instructions are configured to run a threshold timer for periodically triggering an examination of the cache, examine the at least one cache row when periodically triggered by the threshold timer, and perform at least one of the following operations after examining the at least one cache row: flush the at least one cache row to copy the digital data included in the cache row into the main memory, and invalidate the at least one cache row to mark the digital data included in the cache row as eligible for replacement.

Various exemplary embodiments may also relate to a machine-readable medium encoded with instructions executable by a processor, wherein the instructions are configured to run a threshold timer for periodically triggering an examination of a cache, the cache comprising a plurality of cache rows connected between the processor and a main memory, and the cache duplicates an original value of digital data stored in the main memory into at least one cache row of the plurality of cache rows, and enables access by the processor to the digital data in each cache row, examine the at least one cache row when periodically triggered by the threshold timer, and perform at least one of the following operations after examining the at least one cache row: flush the at least one cache row to copy the digital data included in the cache row into the main memory, and invalidate the at least one cache row to mark the digital data included in the cache row for replacement.

Various embodiments may also relate to a method of detecting and preventing parity errors in static cached memory, the method comprising: a processor running a threshold timer for periodically triggering an examination of a cache, the cache comprising plurality of cache rows, wherein the cache is connected between a main memory storing digital data and the processor, examining the at least one cache row when periodically triggered by the threshold timer, and performing at least one of the following operations after examining the at least one cache row: flushing the at least one cache row to copy the digital data included in the cache row into the main memory, and invalidating the at least one cache row to mark the digital data included in the cache row as eligible for replacement.

It should be apparent that, in this manner, various exemplary embodiments enable prevention of information errors in the L1 cache memory through periodic flushing of contents of the data cache memory and periodic invalidating of the contents of the data and instruction cache memories. In this manner, the contents of each cache are cleared from the cache memory and recalled from the main memory before they may be corrupted, drastically decreasing system downtime and network maintenance costs associated with repairing such corruption.

### BRIEF DESCRIPTION OF THE DRAWINGS

In order to facilitate better understanding of various exemplary embodiments, reference is made to the accompanying drawings, wherein:

FIG. 1 is a schematic diagram of an exemplary cache corruption prevention system, the system including a memory hierarchy with a cache memory;

FIG. 2 is a schematic diagram of an exemplary cache memory and its constituent elements;

FIG. 3 is a schematic diagram of the exemplary cache corruption prevention system, including exemplary entries in the cache and main memories;

FIG. 4 is a flowchart of an exemplary embodiment of a method of cache corruption prevention;

FIG. 5 is a flowchart of a particular exemplary embodiment of a method of cache corruption prevention, wherein all entries in the cache are invalidated;

FIG. 6 is a flowchart of a particular exemplary embodiment of a method of cache corruption prevention, wherein modified cache entries are flushed and invalidated; and

FIG. 7 is a flowchart of a particular exemplary embodiment of a method of cache corruption prevention, wherein cache entries stored the longest in the cache are flushed and invalidated.

### DETAILED DESCRIPTION

Referring now to the drawings, in which like numerals refer to like components of steps, there are disclosed broad aspects of various exemplary embodiments.

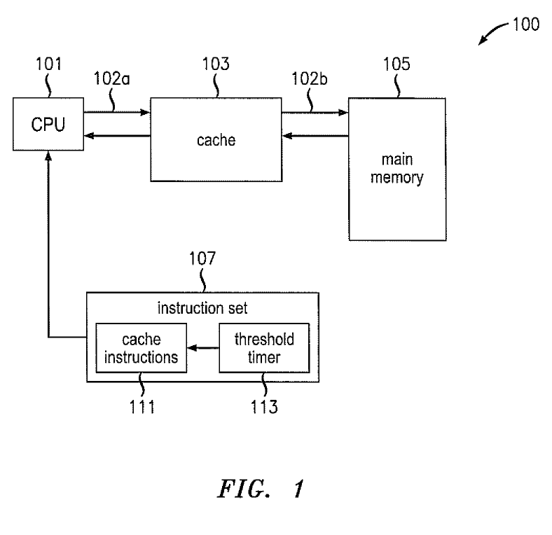

FIG. 1 is a schematic diagram of an exemplary corruption prevention system 100, including a memory hierarchy with a cache memory. Corruption prevention system 100 may comprise a central processing unit (CPU) 101, a cache memory 103, a main memory 105, and an instruction set 107, which includes cache instructions 111 and threshold timer 113.

It should be apparent that the system illustrated may be an abstraction of the structural arrangement of the components. For example, in operation, instruction set 107 may be saved in the main memory 105. In addition, the cache memory 103 may comprise multiple cache memories, such as for example, an L1 cache memory, which may be located on the central processing unit 103, and an L2 cache, which may be located on a separate chip from the CPU 103 and the main memory 105. Suitable arrangements of the components of system 100 will be apparent to those of skill in the art.

The central processing unit (CPU) 101 may be a processor that carries out instructions of a computer program. The CPU 101 may be a microprocessor, such as, for example, an Intel Pentium or MIPS 24K/34K microprocessor that uses a least recently used (LRU) replacement strategy, as will be discussed in further detail below. The CPU 101 may be capable of executing instructions to run a program that may be stored in a computer memory, such as a program stored in main memory 105. The instructions that the CPU 101 is capable of executing may be, for example, fetch, decode, execute, and writeback.

The fetch instruction, for example, may entail the CPU 101 retrieving an instruction from memory. The instruction may be stored in the main memory 105, or may be stored in the cache memory 103. The decode and execute instructions may entail the CPU 101 interpreting the retrieved instructions into executable instructions and implementing the instructions, respectively.

In addition, the writeback command may involve the CPU 101 writing the results of an executed instruction into some form of memory. This may involve the CPU 101 writing data into the cache memory 103 and the CPU 101 writing data into the main memory 105. The CPU 101 may write data into both components simultaneously or may write data into the components separately. There may be information saved in the main memory 105, for example, that the CPU 101 cannot overwrite, even if the CPU 101 modifies the data. This saved information may be, for example, an instruction stored in the main memory 105. Accordingly, in some embodiments, the CPU 101 may be unable to perform the writeback step to overwrite the instructions stored in the main memory 105.

The system buses 102a, 102b may connect components of the corruption prevention system 100 together and may transfer data between these components. Thus, system bus 102a may connect the CPU 101 to the cache memory 103, while system bus 102b may connect the cache memory 103 with the main memory 105. The system bus 102a, 102b may be a physical arrangement of multiple parallel connections between components. The system bus 102a, 102b may also be any physical arrangement that maintains the same logical function as the parallel connections.

System bus 102a may be, for example, a back-side bus, which may be used in conjunction with a front-side bus in a dual-bus architecture. The system bus 102a, 102b may be designed to minimize delay. Delay in the bus may be due to the bus length and limitations in bandwidth. Accordingly, system bus 102a, 102b may be short to limit delays due to length and the system bus 102a, 102b may comprise multiple connection points in order to provide greater bandwidth.

The cache memory 103 may be connected between the CPU 103 and the main memory 105 through a series of system buses 102a, 102b. The cache memory 103 may duplicate information that is stored in main memory 105 and fetched by CPU 101. When the CPU 101 tries to fetch the same information again, the cache memory 103 may provide the CPU 101 with the information without requiring a fetch of the information from the main memory 105.

The cache memory 103 may be made from dynamic random access memory (DRAM) or other memory capable of responding quickly to the fetch instructions of the CPU 101. The cache memory 103 may be made from memory equivalent to DRAM that is also faster than the memory that comprises the main memory 105 (such as, for example static RAM). As the memory that makes up the cache may cost ten times as much for the same amount of storage space, the cache may be much smaller than the main memory. Accordingly, the information stored in the cache memory 103 may be constantly overwritten during fetch and writeback commands.

Though illustrated in the embodiment as a single component, the cache 103 may comprise several separate components. The cache memory 103 may be two or more separate caches, such as an L1 cache memory, which may be located on the same chip that contains the CPU 101, and an L2 cache memory, which may be located on a separate chip. As will be apparent to those of skill in the art, the embodiments disclosed herein are equally applicable to L1, L2, and L3 caches.

The cache memory 103 may also contain two separate logical caches, such as, for example, an instruction cache and a data cache. The computer system 100 may be capable of storing saved information in either of the two logical caches based on the content of the information. Accordingly, instructions may be saved in the instruction cache and other data may be saved in the data cache.

The cache 103 may connect to the main memory 105 through bus 102b. The main memory 105 may store information that may be accessed by the CPU 101. The main memory 105 may be much larger than the cache 103, but the time required for the CPU 101 to complete a fetch command on the main memory 105 may be much larger. Accordingly, during a fetch command, the CPU may retrieve the information from the main memory 105. When accessed, the main memory 105 may provide the requested data both to the CPU 101 and to the cache memory 103. During subsequent requests, if the information is still stored in the cache memory 103, a fetch instruction from the CPU 101 may only reach the cache memory 103, with the main memory never receiving the fetch request.

The instruction set 107 may include executable instructions provided to the CPU 101 and cache memory 103 that may be used by the CPU 101 and cache memory 103 to perform defined actions. The instruction set 107 may include cache instructions 111 and a threshold timer 113. The instruction set 107, though illustrated as a separate component from the main memory 105, may be stored as a set of instructions in the main memory 105. Accordingly, the CPU 101 may use the same fetch, decode, execute, and writeback commands for retrieval and execution of instruction set 107 as it would on other blocks of information stored in the main memory 105.

The cache instructions 111 may be a set of instructions to be executed by the CPU. As will be discussed in further detail below, these instructions may include checking one or more fields in a cache row and taking action based on the field value(s). For example, the cache row may include a valid bit field. When the valid bit field has a value, such as, for example, “0,” the cache instructions 111 may dictate that the cache row is invalid and therefore eligible to be overwritten. The cache instructions may also involve comparing the fields with fields in other components, such as the main memory 105. The cache instructions 111 may also include, for example, changing the value of a field in a cache row.

The cache instructions 111 may involve actions taken on the cache memory 103 executed by components such as the CPU 101 and may involve other components, such as, for example, the main memory 105. The cache instructions 111 may also involve the fetch, decode, execute and writeback processor instructions. The cache instructions may be executed by the CPU 101 or components within the cache memory 103.

The instruction set 107 may also include a threshold timer 113. The instruction set 107 may have its threshold timer 113 base its time from a clock in system 100. Other suitable implementations will be apparent to persons of skill in the art, such as, for example, using a series of delay buffers. As will be discussed in further detail below, the threshold timer 113 may trigger specific cache instructions 111 when reaching a specified trigger value. For example, a threshold timer may be set to periodically trigger every one second. When the threshold timer reaches the trigger value of one second (or two seconds, etc.), the timer may cause the cache memory 103 to execute a cache instruction 111, such as, for example, a cache instruction 111 to check the entire cache memory 103 for cache rows that have been modified but not yet saved into the main memory 105. The threshold timer 113 may contain different trigger values for different cache instructions, such as, for example having a trigger value of 1 second for initiating a check of the cache for unsaved, modified data values and having a 10 minute trigger value for initiating an invalidation (marking a cache row eligible for overwriting) every ten minutes. Other suitable time periods for threshold timer 113 would be apparent to those of ordinary skill in the art.

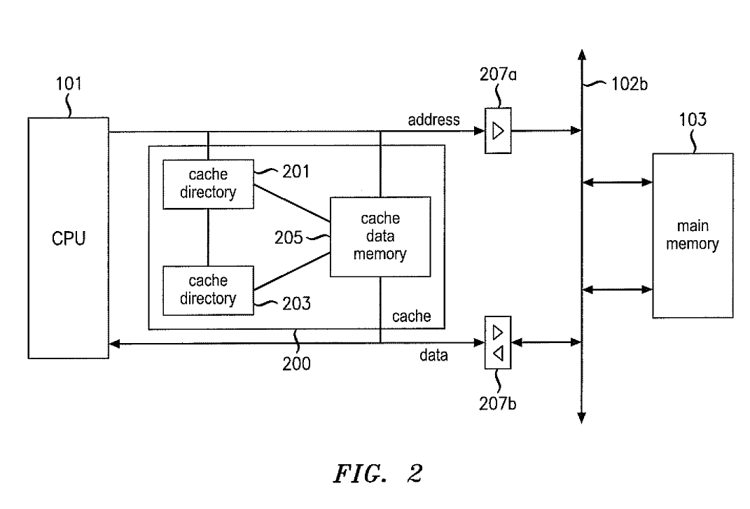

Having described the components of system 100, a brief summary of the operation of system 100 will be provided. It should be apparent that the following description is intended to provide an overview of the operation of system 100 and is therefore a simplification in some respects. The detailed operation of system 100 will be described in further detail below in connection with FIGS. 2-7.

In operation, the cache memory 103 may deliver information to the CPU 101 faster than the main memory 105 can similarly deliver the same information. However, the materials used to make the cache memory 103 are more expensive than the main memory 105 and thus may be smaller than the main memory. The cache memory 103 therefore consistently copies data from the main memory 105 so that, on subsequent requests by the CPU 101, the cache memory 103 may deliver the data faster than the main memory 105. Because the cache memory 103 is smaller than the main memory 105, the contents of the cache memory 103 may be constantly overwritten. As the contents change, the risks of corruption associated with contents remaining in the cache memory diminishes, as contents may not be stored in the cache memory long enough become corrupt.

For contents that are constantly in the cache, however, the cache corruption prevention system 100 may force the values to be overwritten. This may involve the use of a timer to periodically update the main memory 105 from the cache memory 103 and may also involve the periodically invalidating the contents in the cache so that they may be overwritten. Accordingly, in this manner, all contents of the cache may be constantly overwritten, even if they remain in the cache for long duration of time. This may minimize the probably of corruption of the cache contents due to the decreased duration of time for which a modified data block resides in the cache.

In addition, the system 100 may periodically save the modified cache values in the main memory 105. Accordingly, in this manner, the system may increase the probability of successful recovery from a cache parity error due to the modified contents being saved in the main memory 105, while also maintaining a high performance benefit associated with using the cache memory 103.

Referring now to FIG. 2, a schematic diagram of an exemplary embodiment of the cache memory 200 is illustrated. The cache memory 200 may be an embodiment of the cache memory 103 of FIG. 1. The cache memory 200 is connected between the CPU 101 and the system bus 102b connected to main memory 105. In the illustrated embodiment, the cache memory 200 includes cache directory 201, cache controller 203, cache data memory 205, and a series of buffers 207a, 207b. Various embodiments may include multiple cache memories 103, where the component parts 201-207 may be duplicated for each cache memory. This may include L1 and L2 cache memories and instruction and data cache memories.

Inside the cache memory 200, the cache directory 201 may be connected to the CPU 101 and may contain a series of entries for each block of information stored in the cache data memory 205. As will be discussed below, the cache directory 201 may comprise a series of cache rows that contain both an address block and a data block. The data block may contain the information stored in the main memory data block that was copied into the cache and the address block may contain, among other fields, address references to the information in the main memory 105. The cache directory 201 may list the main memory addresses of the information stored in corresponding locations of the cache data memory 205. For example, information coming from the address “00010” in the main memory 105 may contain a representation in the cache directory 201 that represents main memory address “00010.” This representation may be literal or may be a derivative of the main memory address.

The cache controller 203 may be connected to the cache directory 201 and the cache data memory 205 and may contain control logic that may implement instructions to carry out on the cache directory 101 and the cache data memory 205, such as cache instructions 111 that move data into and out of the cache data memory 205 and cache directory 201. The cache controller 203 may also determine when to turn on and off the buffers 207a, 207b.

The cache data memory 205 may be connected to the cache directory 201 and cache controller 203 and may store information initially saved in the main memory 205 in the form of a cache row. The cache data memory 205 may store both data and instructions. The cache data memory 205 may store the data and instructions together in a unified cache, or may store them separately in a data cache and an instruction cache. The CPU 101 may modify the data block for data stored in the cache data memory 205, but may not modify the data block for instructions stored in the cache data memory 205.

The buffers 207a, 207b may be located between the cache data memory 205 and the system bus 102b connecting to the main memory 105. The buffers 207a, 207b may be identical, or the buffers may be split into an address buffer 207a and a data buffer 207b. The data buffer 207b may allow bi-directional transfer of information stored in the main memory 105, while the address buffer 207a may only allow unidirectional requests from the CPU 101 to the main memory 105. The buffers 207a, 207b may be controlled by the cache controller 203 so that when the cache data memory 205 can supply information requested by the CPU 101, the buffers 207a, 207b block communications between the CPU 101 and the main memory 105, blocking the slower data retrieval from the main memory 105.

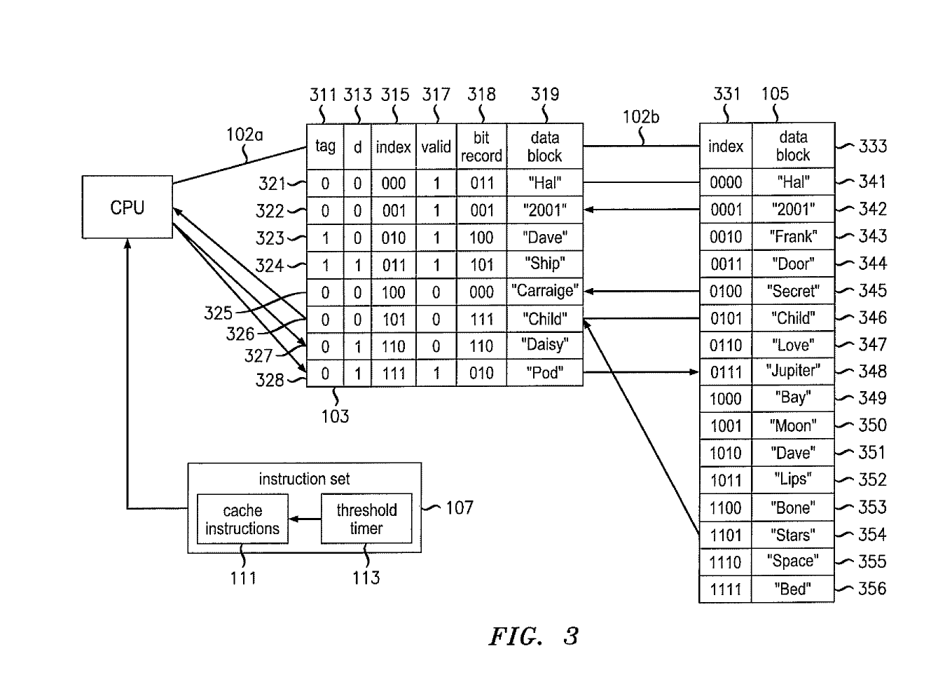

FIG. 3 is a schematic diagram of the exemplary cache corruption prevention system 100, including exemplary entries in the cache and main memories. The components in FIG. 3 correspond to the components of the exemplary cache corruption prevention system of FIG. 1. The cache memory 103 is illustrated showing the contents of an exemplary cache directory 201. The illustrated cache memory 103 may be a data cache that may include a series of cache rows 321-328, which may also be known as cache lines. Each cache row 321-328 may include a data block 319 and a series of fields 311-318, including a tag field 311, a dirty bit field 313, an index field 315, a valid bit field 317, and a bit record field 318.

The main memory 105 may include a series of memory rows 341-356. Each memory row 341-356 may include a data block 333 in addition to an index field 331. Various embodiments, as known to a person of ordinary skill in the art, may involve the association of specific rows in the cache (cache rows) to specific rows in the main memory (main memory). This may include a set association, direct association, and N-way association between the cache memory 103 and the main memory 105.

The cache controller 203 may use the main memory index bits 331 to correlate with the cache tag 311 and cache index 315 bits stored in the RAM. The cache tag bits 311 may be compared with the higher order bits of the memory index 331. If the tag bit 311 and high-order index bit 331 match each other, the information in the data block 319 of the cache memory 103 may therefore correspond to the information in the data field 333 of the main memory 105 at the corresponding address.

The cache memory 103 of FIG. 3 is an exemplary embodiment of a set associative cache, with the cache memory 103 holding 8 cache rows 321-328 and the main memory 105 holding 16 memory rows 341-356. As the main memory 105 is twice as large as the cache memory 103, the tag field 311 may be as small as one bit to identify, in conjunction with the index field 315 of the cache memory 103, the corresponding index 331 in main memory 105. The index field 315 of the cache memory 105 may therefore represent the least significant values of the index 331 in the main memory 105.

In the illustrative embodiment, for example, cache row 326 has an index of “101.” Accordingly, the memory row 346 with an index 315 of “0101” and the memory row 354 with an index 315 of “1101” may store information in the cache row 326. The tag 311 may therefore indicate which address is currently stored in the cache memory 103. In the illustrative example, the tag 311 of “0” may indicate that the memory row 346 with corresponding index 331 of “0101” is currently stored in the cache row 326. If the CPU 101 subsequently requests the “0101” address, it may be retrieved from the cache memory 103. Alternatively, if the CPU 101 requests the “1101” address, the cache controller 203 may overwrite cache row 326 with the information contained in corresponding “1101” memory row 354.

The cache memory 103 may also keep track of when a cache row 321-328 was last accessed. The bit record 318 may track how long cache rows 321-328 have been in the cache memory 103. The bit record 318 may be a record relative to other cache rows 321-328 in the cache memory 103 (e.g., “111” to represent the cache row with the longest time stored and “000” to represent the cache row with the shortest time stored), or the bit record 318 may be, for example, a value derived from the system clock. The bit record 318 may be derived from both processor instructions and/or cache instructions 111, such as, for example the cache miss operation that may overwrite invalid cache rows 321-328.

A cache controller 203 may implement a replacement operation, which may also be known as a replacement strategy, to replace specific cache rows 321-328 based on specific criteria. For example, the cache controller 203 may implement a least recently used (LRU) replacement strategy to invalidate and overwrite cache rows 321-328 that have gone the longest without being requested by the CPU 101. The bit record 318 may also be derived from other processor operations that track how long a cache row 321-328 has stayed stored in the cache memory 103 and how long a cache row 321-328 has stayed in the cache memory without being updated and flushed into the main memory 105.

In the illustrative embodiment, cache row 326 has remained in the cache memory 103 the longest, as signified by its bit record 318 being “111.” The cache controller 203 may subsequently invalidate the cache row 326, forcing the CPU 101 to retrieve the information from memory row 346, which the cache controller 203 may again copy into the cache row 326 even if the value did not change.

There are a number of possible operations that involve the cache memory 103. These operations may involve the evaluation of bits in the cache row 321-328, such as, for example, the dirty bit 313, the valid bit 317, and the bit record 318. The cache controller 203 may take actions based on the value of the bits in the cache row 321-328, such as, for example, sending the information stored in the cache memory 103 to the CPU 101, updating the value of the data block 333 in the main memory 105 from the data block 319 in the cache memory 103, and invalidating the cache row 321-328. These operations may also involve standard processor operations, such as, for example, fetch and writeback operations.

During a processor fetch operation, the cache controller 203 may compare the address block requested by the CPU 101 with the tag 311 and index 315 values of the cache rows 321-328 in the cache memory 105. If the tag 311 and index 315 values of a cache row 321 matches the requested address, a cache hit occurs and the cache controller 203 sends the corresponding value in the data block 319 from that cache row 321 the CPU 101. During a cache hit, the address buffer 207a may prevent the address request from reaching the main memory 105 and the data buffer 207b may prevent data from transferring from the main memory 105 to the CPU 101.

As an example, CPU 101 may request address “0101.” The cache controller 203, upon finding the valid address block of tag 311 “0” and index 315 “101” in cache row 326, may use buffers to block the CPU 101 request from reaching the main memory 105. The cache controller 203 may then have the cache data memory 205 deliver the information, including the data block 319 “Child” to the CPU 101.

If the tag 311 and index 315 values do not match the requested address, then a cache miss occurs and the requested data may not be in the cache memory 105 and the request may travel through the address buffer 207a to the main memory 105 for proper data. The cache controller 203 may intercept the data transferring from the main memory 105 to the CPU 101 and store the new information in the appropriate cache row in the cache memory 103. This may overwrite information that was previously stored in the cache memory 103.

As another example, the CPU 101 may request address “1101.” The cache controller 203 may not find the matching tag 311 and index 315 values in any of the rows, as cache row 326 is currently storing the information from memory row 346. The cache controller 203 may then allow the CPU 101 request to reach main memory 105. The main memory 105 may then deliver memory row 354 at index 331 “1101,” including data block 333 “Stars” to the CPU 101. The cache controller 203 may then copy the information from the memory row 254 into the cache memory 103, overwriting the current cache row 326.

The cache controller 203 may also invalidate a cache row 321-328. A cache row 321-328 marked as invalid may be an invalid cache row 325, which may be marked for overwriting during subsequent cache miss operations. A cache row 325 may be marked as invalid using, for example, a valid bit 317 in the cache row 325. The valid bit 317 may be part of the address block in conjunction with the tag 311 and the index 315 bits. The cache controller 203 may not recognize the cache row 325 to be valid, and the cache controller 203 may therefore not use the invalid cache row 325 to respond to a CPU 101 fetch request. The cache controller 203 may not respond by delivering cache row 325 to the CPU 101 even if cache row has the tag 311 and index 315 corresponding to the requested address. The cache controller 203 may therefore allow the CPU 101 request to reach the main memory 105 and the cache controller 203 may copy the memory row sent from the main memory 105 to the CPU 101, overwriting the cache row 325 with the new information, similar to the actions during a cache miss operation.

A write-back operation may entail that data written into the cache memory 103 by the CPU 101 is not updated to the corresponding memory row in the main memory 103 until a specified time occurs. The CPU 101 updating the value in the cache data block 319 may cause the cache controller 103 to change the value of the dirty bit 313. The dirty bit 313 may signify that a cache row 328 has been modified but not yet saved in the main memory 105. The updating of the main memory 105 may be an automatic function by the CPU 101 known as a writeback. This updating of the main memory 105 may also be triggered manually. Such a manual update may be known as “flushing” the cache memory 103 into the main memory 105. The cache controller 203 may update each cache row 321-328 individually. The cache controller 203 may control a writeback of flush of a cache row 328 and may invalidate the cache row 328 only after updating the main memory 105 with the modified value.

As another example, suppose CPU 101 seeks to change the value of the information stored in cache row 328. The cache controller 203, upon receiving the modified data block 319 for the address “0111” may then update the data block 319 with the new value and also change the dirty bit 313 to “1,” signifying that the cache value of cache row 328 has modified, but not yet been saved into the main memory 105 at row 348. During a subsequent writeback or flush operation, the cache controller 203 may then send the cache row 328 to the main memory 105, which updates the data block 333 from “Jupiter” to “Pod.” The cache controller 203 may then change the dirty bit 313 back to “0.” The cache controller may employ a policy of always checking the dirty bit and flushing the cache row before overwriting a cache row 321-328.

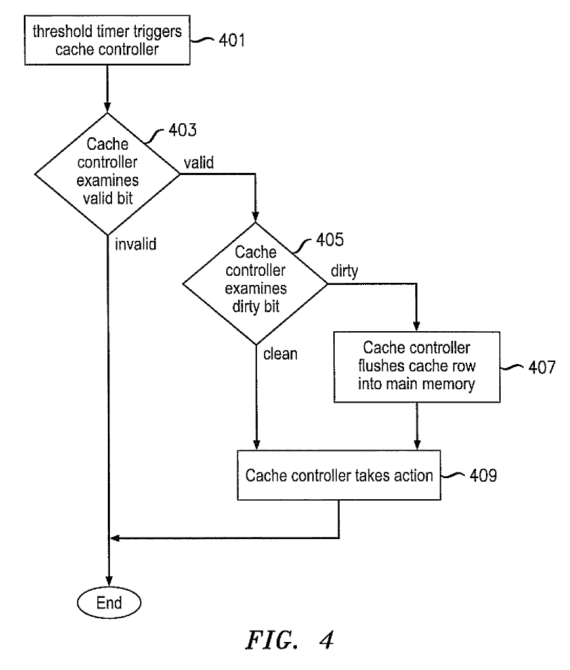

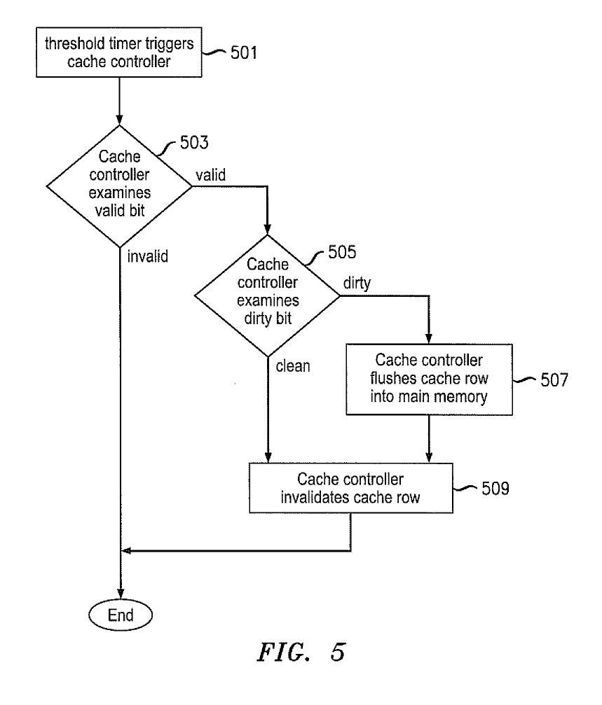

FIG. 4 is a flowchart of an exemplary embodiment of a method 400 of cache corruption prevention. Specific implementations will be described in further detail below in connection with FIGS. 5-7.

Method 400 may involve the use of the threshold timer 113 to periodically trigger the CPU 101 and cache controller 203 to execute instructions involving the cache memory 103. The instructions may involve examining the dirty 313 and valid 317 bits of each cache row and performing a flush and/or invalidate operation on the cache row based on the value of these bits.

Method 400 may result in the main memory 105 being updated periodically and a series of cache rows being invalidated periodically. As will be apparent to those of skill in the art, method 400 may provide advantages over the standard processor write-through operation, which performs a write-back operation every time a value is fetched from the cache and therefore loses some of the performance benefits of using a cache due to constant updating of the main memory 105.

Starting in step 401, the threshold timer 113 may reach a specified value that may trigger an operation. The specified value of threshold timer 113 may be set manually or preconfigured to a specific value. In various embodiments, the threshold timer 113 may use different timing values to trigger different operations. For example, the threshold timer 113 may trigger the cache controller 203 to perform the flush operation on all the modified cache rows 321-329 every 5 seconds and may separately trigger the cache controller 203 to invalidate all cache rows 321-329 in the cache memory every 10 minutes. Upon reaching the specified value, the threshold timer may trigger an action from the cache controller 203 or in the CPU 101.

Continuing to step 403, the cache controller 203 examines the valid bit 317 of cache row 327 to determine if the cache row 327 is still valid. In the illustrative embodiment, the valid bit may contain either the value of “1” or “0,” with the value of “0” signifying that a value is invalid and is eligible to be overwritten.

If the valid bit 317 signifies that the cache row 327 is invalid, the cache controller 203 does not modify the cache row 327. The cache controller 203 treats the cache row 327 as an invalid row, which means that the cache controller 203 does not return the value of data block 319 when the tag 311 and index 315 bits of the cache row 327 match a CPU 101 request for that address. This also means that the cache controller 203 may overwrite the cache row 327 during a subsequent cache miss, where the cache controller 203, needing space in the cache memory 103, overwrites invalid cache rows first when copying values into the cache memory 103.

Alternatively, if the valid bit 317 signifies that the cache row is valid, the cache controller 203 in step 405 may examine the value of the dirty bit 313 in a cache row 321-329. In the illustrative embodiment, the dirty bit may contain either the value of “1” or “0,” with the value of “1” signifying that a value is “dirty,” i.e., modified and unsaved in the main memory 105.

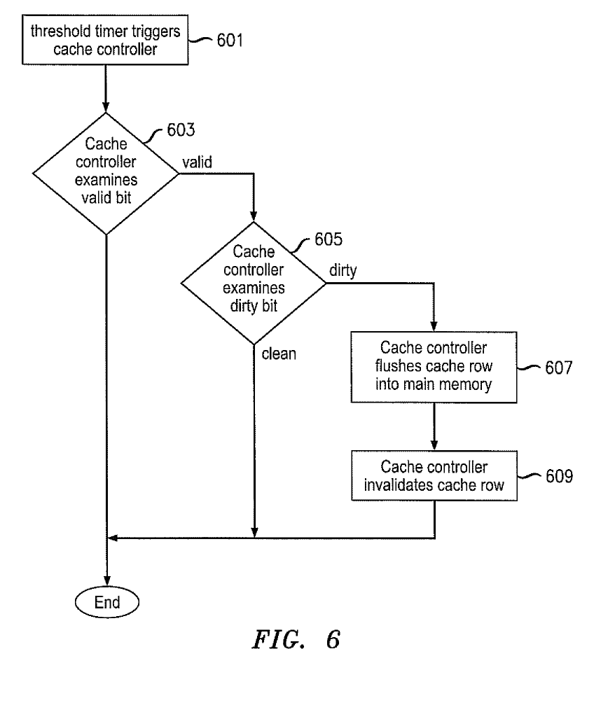

If the dirty bit 313 signifies that the cache row 326 is dirty, the cache controller in step 407 flushes the dirty cache row 326 into the main memory. In the illustrative embodiment of the system in FIG. 3, “1” may represent that a cache row 321-329 is dirty. The step of flushing the dirty cache row 326 may involve modifying the value of the data block 333 at the corresponding “0111” address in the main memory 105 and changing the value of dirty bit 313 in cache row 326 from “1” to “0.” An exemplary embodiment of this method is discussed in further detail below in reference to FIG. 6.

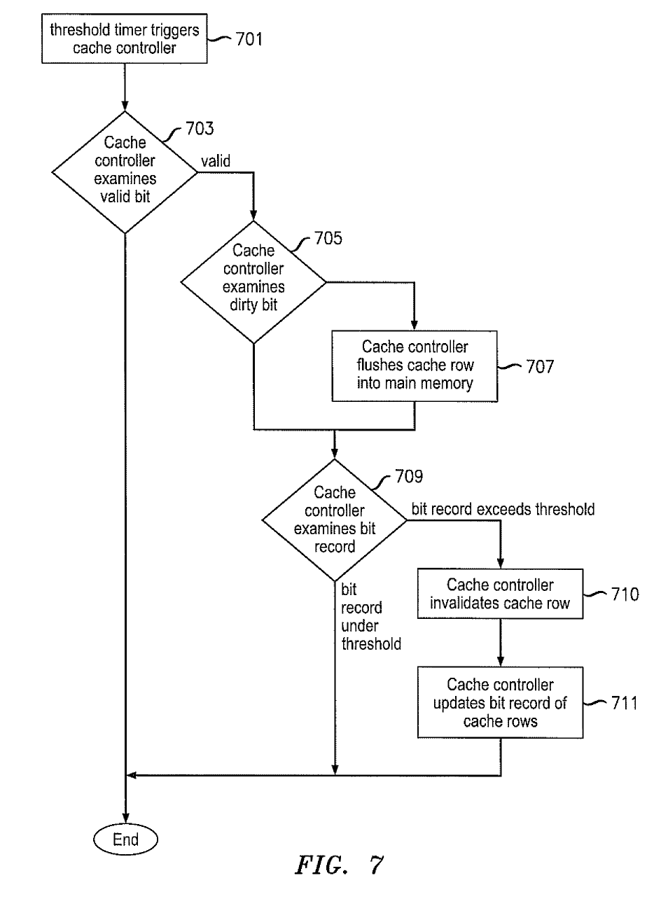

Step 409 follows step 405 when the cache controller 203 determines that the cache row 325 is not dirty and follows step 407 when the cache controller 203 determines that the cache row 326 is dirty and subsequently flushes the modified value back into the main memory 105. In step 407, the cache controller 203 in step 409 may take a predetermined action. This predetermined action may be, for example, to always have the cache controller 203 invalidate a cache row 321-329 (described below with reference to FIG. 5). The action may involve the cache controller 203 invalidating a cache row 321-329 if the cache controller recently flushed the value of the cache row 321-329 into the main memory 105 (described below with reference to FIG. 6). The action may also be to invalidate the cache row 321-329 based on the value of the bit record 318 (described below with reference to FIG. 7). Other actions by the cache controller 203 will be apparent to persons of ordinary skill in the art.

FIG. 5 is a flowchart of a particular exemplary embodiment of a method 500 of cache corruption prevention, wherein all entries in the cache are invalidated. FIG. 5 may be an exemplary embodiment of the method 400 as illustrated in FIG. 4.

Method 500 closely follows the method 400, where step 501 uses a threshold timer to trigger the cache controller 203 in step 503 to examine the valid bit 317 of each cache row 321-329, correlating to steps 401 and 403 of method 400. Step 505 correlates to step 405, where the cache controller 203 examines the dirty bit 313 of cache row 321-329 to determine if the cache row has been modified. Step 507 correlates to step 407, where the cache controller 203 flushes the modified value of a dirty cache row 326 into the main memory when it determines that the cache row is dirty. Step 509 correlates to step 409, where the cache controller 203 takes a subsequent action.

In method 500, the cache controller 203 takes the specific subsequent action of invalidating every cache row 321-329 in the cache memory 103. Method 500 may therefore set a threshold upper bound of time for which any cache row 321-329 may be stored in the cache memory 103. If, for example, the threshold timer for step 501 is set to 10 minutes, then the longest any cache row 321-329 can remain in the cache memory 103 is 600 seconds. This may be true even if the CPU 101 constantly conducts a cache hit on a data row 321, which may preclude the cache controller 203 from overwriting the cache row 321. This maximum time limit may minimize the probability of a corrupted value in a cache row 321-329, as the time limit minimizes the time any cache row 321-329 may be stored in the cache memory 103.

FIG. 6 is a flowchart of a particular exemplary embodiment of a method 600 of cache corruption prevention, wherein modified cache entries are flushed and invalidated. The method 600 of FIG. 6 may be an exemplary embodiment of method 400 as illustrated in FIG. 4. Method 600 closely follows the method 400, with steps 601, 603, 605, and 607 correlating to steps 401-407 of method 400. However, in method 600, step 609 only follows step 607. In step 609, the cache controller 203 changes the valid bit 317 value of a cache row 327 to invalid after the cache controller 203 flushes the value into the main memory 105. Accordingly, any cache row 321-329 that was dirty in step 605 is marked as invalid.

Method 600 may therefore act as a periodic writeback operation for modified values in the cache memory 103. Instead of always writing a value from the cache row 103 into the main memory 105 every time, as in write-through or using the automatic processor writeback operation, a user can set a periodic time to perform writeback operations for values in the cache memory 103. For example, a threshold period of one second (1 s) may enable writeback of modified cache values into the main memory 105, but the periodic trigger maintains the performance benefit of using the cache memory 103 by only updating the main memory at specific time intervals, minimizing unnecessary updates of the main memory 105. The system 100 may therefore increase the probability of successful recovery from a cache parity error while maintaining the performance benefit associated with using the cache memory 103.

FIG. 7 is a flowchart of a particular exemplary embodiment of a method 700 of cache corruption prevention, wherein cache entries stored the longest in the cache are flushed and invalidated. Method 700 of FIG. 7 may be an exemplary embodiment of method 400 as illustrated in FIG. 4. Method 700 closely follows the method 400, with steps 701, 703, 705, 707, and 709 correlating to steps 401-409 of method 400.

However, in method 700, step 710 may further entail invalidating a cache row based on, for example, the length of time it has been stored in the cache memory 103. In step 709, the cache controller 203 may examine a value in the cache row 321-329 to determine, for example, the length of time a value has been stored in the cache. In the illustrative embodiment, the cache controller 203 may examine the bit record 318 of a cache row 322 to determine the length of time it has remained in the cache memory 103. The bit record 318 may be, for example, a value derived from another operation by the CPU 101 and/or cache controller 203, such as least recently used (LRU) values that may keep track of how long a cache row 321-329 has been stored in the cache memory 103.

In step 710, the cache controller 203 may invalidate a cache row based on the examined value. In the illustrative embodiment, the cache controller 203 may invalidate a cache row 324 based on the value of the bit record 318. The bit record 318 may be relative to other cache rows. For example, in the illustrative embodiment, the bit record may be a binary value from “000” to “111,” with “000” signifying the cache row 324 that has been saved in the cache memory for the longest period of time. In the illustrative embodiment, the cache controller 203 may, for example, implement a policy of invalidating the cache row 321-329 that has been in the cache memory 103 for the longest time. In various embodiments, the cache controller may employ a policy of invalidating a cache row 321-328 that has been in the cache memory 103 for a long time, such as, for example, cache rows 321-328 whose content has been saved in the cache memory for 10 minutes. Accordingly, the cache controller may in step 710 determine that cache row 324 has been in the cache memory for a threshold period. In the illustrative embodiment, the cache 324 has been in the cache memory 103 the longest, as it has “000” as its bit record 318. As the exemplary cache controller 203 invalidates the cache row 321-328 that has been in the cache memory 103 for the longest time, in step 710, the cache controller 203 invalidates the cache row 324.

In various embodiments method 700 may execute step 711, where the cache controller 203 updates the relative bit records 318 of the cache rows in the cache memory. In the illustrative embodiment, the cache controller 203 may update the values of each cache row 321-329, changing, for example, the bit record of 326 from “0001” to “0000,” as the cache row 326 has now been in the cache memory 103 for the longest time interval.

Method 700 may therefore periodically remove cache rows that have been stored in the cache memory 103 for the longest time. Generally, the cache rows 321-329 that have been stored in the cache memory 103 for the longest periods may be called constantly by the CPU 101 without ever being overwritten. Method 700 may therefore selectively target the cache rows 321-329 that have been in the cache memory 103 for the longest periods, as these cache rows 321-329 may have the highest probability of becoming corrupted in the cache memory 103.

In view of the foregoing description with reference to FIGS. 1-7, various exemplary embodiments minimize corruption in the cache memory and increase the probability of successful recovery from cache parity error by saving modified cache values into the main memory 105 and periodically invalidating cache rows 321-329 so that they can be constantly overwritten no matter how often they are called by the CPU 101. The cache processor 203 may implement specific policies to be used in conjunction with the threshold timer 113 in both flushing modified cache values into the main memory 105 and invalidating cache rows 321-329 stored in the cache memory 103.

These policies may include, for example, periodically invalidating every cache row, invalidating dirty cache rows after they are periodically flushed into the main memory, and periodically invalidating cache rows that have stayed in the cache memory for the longest time. The cache controller may implement multiple policies using multiple threshold times. The system may therefore prevent corruption in cache rows and minimize loss of modified cache values by periodically updating the main memory 105 and preventing any particular cache row 321-329 from staying in the cache memory 103 too long before it is overwritten by the cache controller 203.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications may be implemented while remaining within the spirit and scope of the invention. Accordingly, the foregoing disclosure, description, and figures are for illustrative purposes only and do not in any way limit the invention, which is defined only by the claims.

What is claimed is:

1. A system for detecting and preventing cache corruption in cache memory, the system comprising:
a processor for performing a series of instructions;
a main memory for storing digital data;
a cache comprising a plurality of cache rows, wherein the cache is connected between the main memory and the processor, and the cache:
duplicates an original value of the digital data stored in the main memory into at least one cache row of the plurality of cache rows, and
enables access by the processor to the digital data in each cache row; and
a machine-readable medium encoded with instructions executable by the processor, wherein the instructions are configured to:
run a threshold timer for periodically triggering an examination of the cache,
examine the at least one cache row when periodically triggered by the threshold timer to determine whether the at least one cache row is valid, and
perform at least one of the following operations after examining the at least one cache row:
flush the at least one cache row to copy the digital data included in the cache row into the main memory, and
invalidate the at least one cache row to mark the digital data included in the cache row as eligible for replacement.

2. The system of claim 1, wherein the instructions encoded in the machine-readable medium are further configured to:
flush the at least one cache row into the main memory when the at least one cache row has been modified and not saved to the main memory.

3. The system of claim 1, wherein the instructions encoded in the machine-readable medium are further configured to:
flush the at least one cache row into the main memory when the at least one cache row has been in the cache for a pre-determined time interval.

4. The system of claim 3, wherein the instructions encoded in the machine-readable medium are further configured to:
retrieve a duration of time the at least one cache row has been stored in the cache from the processor executing a replacement policy, wherein the replacement policy specifies which rows in a cache may be erased.

5. The system of claim 4, wherein the processor runs a least recently used (LRU) replacement policy that includes information regarding a duration of time the at least one cache row has been stored in the cache.

6. The system of claim 1, wherein the instructions encoded in the machine-readable medium are further configured to:
invalidate each cache row of the plurality of cache rows when periodically triggered by the threshold timer.

7. The system of claim 1, wherein the instructions encoded in the machine-readable medium are further configured to:
run a threshold timer for a period of one second.

8. The system of claim 1, wherein each row of the plurality of cache rows comprises:
a data block containing the digital data stored in the main memory and copied into the cache;
a memory address identifying the location of the data block in the main memory, the memory address comprising:
a tag identifying whether the stored data block is needed, and
an index identifying the cache row of the cache containing the data block; and
an valid bit indicating when the cache row contains valid data; and
a dirty bit identifying the cache row as containing a modified data block that has not yet been saved in the main memory.

9. The system of claim 8, wherein each row of the plurality of cache rows further comprises:
a bit record indicating the duration of time the cache row has been saved in the cache.

10. A machine-readable medium encoded with instructions executable by a processor, wherein the instructions are configured to:
run a threshold timer for periodically triggering an examination of a cache, the cache comprising a plurality of cache rows connected between the processor and a main memory, and the cache:
duplicates an original value of digital data stored in the main memory into at least one cache row of the plurality of cache rows, and
enables access by the processor to the digital data in each cache row;
examine the at least one cache row when periodically triggered by the threshold timer to determine whether the at least one cache row is valid; and
perform at least one of the following operations after examining the at least one cache row:
flush the at least one cache row to copy the digital data included in the cache row into the main memory, and
invalidate the at least one cache row to mark the digital data included in the cache row for replacement.

11. The machine-readable medium of claim 10, wherein the machine-readable medium includes instructions further configured to:
flush the at least one cache row into the main memory when the at least one cache row has been modified and not saved to the main memory.

12. The machine-readable medium of claim 10, wherein the machine-readable medium includes instructions further configured to:
flush the at least one cache row into the main memory when the at least one cache row has been in the cache for a pre-determined time interval.

13. The machine-readable medium of claim 10, wherein the machine readable medium includes instructions further configured to:
retrieve a duration of time the at least one cache row has been stored in the cache from the processor executing a replacement policy, wherein the replacement policy specifies which rows in a cache may be erased.

14. The machine-readable medium of claim 13, wherein the processor runs a least recently used (LRU) replacement policy and includes information regarding a duration of time the at least one cache line has been stored in the cache.

15. The machine-readable medium of claim 10, wherein the machine-readable medium includes instructions further configured to:
invalidate each cache row of the plurality of cache rows when periodically triggered by the threshold timer.

16. The machine-readable medium of claim 10, wherein the machine-readable medium includes instructions further configured to:
run a threshold timer for a period of one second.

17. A method of detecting and preventing parity errors in static cached memory, the method comprising:
running, by a processor, a threshold timer for periodically triggering an examination of a cache, the cache comprising plurality of cache rows, wherein the cache is connected between a main memory storing digital data and the processor;
examining the at least one cache row when periodically triggered by the threshold timer to determine whether the at least one cache row is valid; and
performing at least one of the following operations after examining the at least one cache row:
flushing the at least one cache row to copy the digital data included in the cache row into the main memory, and
invalidating the at least one cache row to mark the digital data included in the cache row as eligible for replacement.

18. The method of claim 17, further comprising:
flushing the at least one cache row into the main memory when the at least one cache row has been modified and not saved to the main memory.

19. The method of claim 17, further comprising:
flushing the at least one cache row into the main memory when the at least one cache row has been in the cache for a pre-determined time interval.

20. The method of claim 19, further comprising:
retrieving a duration of time the at least one cache row has been stored in the cache from the processor executing a replacement policy, wherein the replacement policy specifies which rows in a cache may be erased.

21. The method of claim 20, wherein the processor runs a least recently used (LRU) replacement policy that includes information regarding a duration of time the at least one cache line has been stored in the cache.

22. The method of claim 17, further comprising:
invalidating each cache row of the plurality of cache rows when periodically triggered by the threshold timer.
